(19) United States
(12) Patent Application Publication
(10) Pub. No.: US 2026/0156595 A1
(43) Pub. Date: Jun. 4, 2026

(54) SYSTEMS AND METHODS FOR NETWORK SELECTION USING GEOLOCATION DATA

(71) Applicant: Verizon Patent and Licensing Inc., Basking Ridge, NJ (US)

(72) Inventors: Andrew E. YOUTZ, Princeton, NJ (US); Yong Sang CHO, Old Tappan, NJ (US); Lily ZHU, Parsippany, NJ (US)

(73) Assignee: Verizon Patent and Licensing Inc., Basking Ridge, NJ (US)

(21) Appl. No.: 18/967,311

(22) Filed: Dec. 3, 2024

(51) Int. Cl. H04W 64/00; H04W 8/00; H04W 84/06

(52) U.S. Cl. CPC H04W 64/00; H04W 8/005; H04W 84/06

(57) ABSTRACT

In some implementations, a UE may receive geolocation data indicating a current location of the UE. The UE may determine a re-scan interval for re-acquiring a terrestrial network based on the geolocation data, wherein a value for the re-scan interval is based on a proximity to an area within the terrestrial network coverage area. The UE may perform, during connectivity with a non-terrestrial network, a set of re-scans for the terrestrial network based on the determined re-scan interval.

### BACKGROUND

A telecommunications system may use multiple types of networks to provide seamless communication coverage for user equipment (UE). For example, the telecommunications system may provide both terrestrial networks (TNs) and non-terrestrial networks (NTNs). A UE can transition between these networks, with terrestrial networks providing coverage from ground-based network nodes and non-terrestrial networks providing coverage from non-ground-based network nodes, such as satellites or unmanned aerial vehicles (UAVs). Non-terrestrial networks may offer coverage improvements for telecommunications systems, by providing coverage in remote or inaccessible areas. As a UE moves, the UE may hand over between types of networks to ensure continuous connectivity. In such an example, both terrestrial and non-terrestrial networks work in tandem to provide uninterrupted service across different UE locations.

### BRIEF DESCRIPTION OF THE DRAWINGS

FIGS. 1A-1D are diagrams of an example associated with network selection using geolocation data.

FIG. 2 is a diagram of an example environment in which systems and/or methods described herein may be implemented.

FIG. 3 is a diagram of example components of a device associated with network selection using geolocation data.

FIG. 4 is a flowchart of an example process associated with network selection using geolocation data.

### DETAILED DESCRIPTION OF EXAMPLE EMBODIMENTS

The following detailed description of example implementations refers to the accompanying drawings. The same reference numbers in different drawings may identify the same or similar elements.

In a telecommunications system, a UE may frequently transition between different types of network coverage as the UE moves between different locations. UEs may connect to terrestrial networks provided by a network operator; however, in areas with no terrestrial network coverage, known as “white spaces,” UEs may instead connect to non-terrestrial networks (NTNs). NTNs provide network coverage via non-ground-based stations, such as network nodes that are deployed (or that have some functionality deployed) at a satellite, an unmanned aerial vehicle (UAV), a manned aerial vehicle (MAV), a blimp, or another non-ground-based platform. Non-terrestrial networks provide valuable coverage extension in white spaces, such as areas with limited access for establishing ground-based stations (e.g., forests, deserts, lakes, oceans, or mountains) or areas with limited demand for establishing ground-based stations (e.g., areas with few users or for which data traffic is limited, such as areas that are used by low-bandwidth machine-type devices (MTCs)), among other examples.

However, non-terrestrial networks (and associated NTN network nodes) may have lower performance than terrestrial networks (and associated TN network nodes). For example, non-terrestrial networks may be associated with reduced throughput, increased latency, or additional overhead signaling relative to terrestrial networks. Additionally, as non-terrestrial networks are deployed via satellites, UAVs, or other non-ground-based platforms, non-terrestrial networks may be associated with higher deployment costs and/or operation costs. Accordingly, it may be desirable for UEs to be transferred from non-terrestrial networks to terrestrial networks when terrestrial networks are available to improve network performance and reduce network costs.

A technical challenge arises when a UE, that is initially operating in an area served by a non-terrestrial network, moves back into an area where terrestrial network coverage should be available. In such an example, the UE should quickly re-acquire a connection to the terrestrial network to benefit from the improved performance and lower operational costs of the terrestrial network relative to the non-terrestrial network. However, UEs may use periodic scanning to detect available networks, a process which consumes battery life. Frequent scanning can rapidly deplete a UE's battery, leading to a poor user experience. Conversely, infrequent scanning can result in delayed reconnection to the terrestrial network, which can also degrade user experience and increase costs due to prolonged use of a non-terrestrial network. Moreover, an additional technical challenge arises in scenarios where a UE is located near a boundary of terrestrial coverage (e.g., a cell edge) or in a small coverage hole within a core network area (e.g., a “white space” within a network area that is within a threshold distance of a cell source or that is associated with at least a threshold network metric, such as a threshold signal strength, other than for the coverage hole), as described in more detail herein. In such cases, the UE may frequently switch, or “ping-pong,” between a non-terrestrial network and a terrestrial network, which can further drain the battery and lead to inconsistent service quality.

Some implementations described herein provide techniques for improving a transition of UE between non-terrestrial networks and terrestrial networks based on geolocation data. For example, a UE may receive geolocation data indicating a current location and determine a re-scan interval for re-acquiring a terrestrial network. In this example, the re-scan interval (e.g., a frequency with which the UE attempts to identify and transfer to a terrestrial network) is based on proximity to an area within the terrestrial network coverage area. In other words, when the UE is far from a location that has been identified as having terrestrial network coverage, the UE may infrequently re-scan for terrestrial networks. In contrast, when a UE is proximate to a location that has been identified as having terrestrial network coverage, the UE may frequently re-scan for terrestrial networks. In some implementations, the UE may configure and use a transition timer to manage a ping-pong effect between networks. For example, the UE may forgo or suspend one or more re-scans, scheduled in accordance with a re-scan interval, during a prohibit time period associated with the transition timer, to avoid frequent reselection between a non-terrestrial network and a terrestrial network, as may occur at a cell edge of the terrestrial network.

In this way, techniques described herein address the technical problem of efficiently transitioning UEs between non-terrestrial networks and terrestrial networks by intelligently managing the re-scan intervals based on the UE's geolocation. The UE can quickly re-acquire terrestrial network coverage when a terrestrial network is predicted to be available, while also conserving battery life by avoiding unnecessary scans when outside the coverage area or when battery levels are low. Additionally, the optimization of scanning intervals based on geolocation and battery metrics conserves processing resources and energy, leading to prolonged UE operation on a single charge. Furthermore, network operators can achieve more efficient utilization of network resources by minimizing the use of more expensive non-terrestrial networks when not necessary, and by improving the allocation of terrestrial network capacity. This leads to a reduction in operational costs, an improvement to network performance, and an enhancement in the overall efficiency of network resource management.

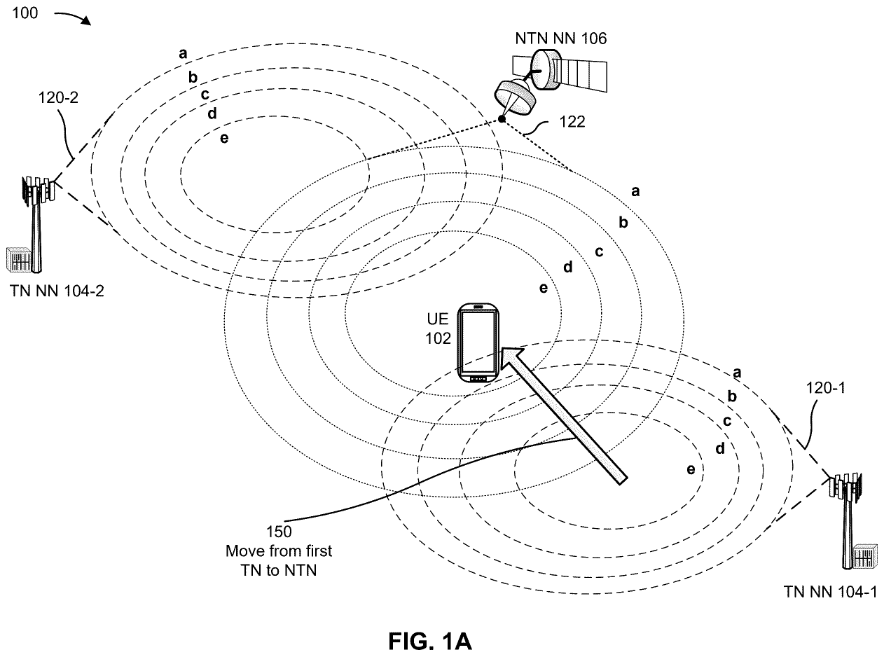

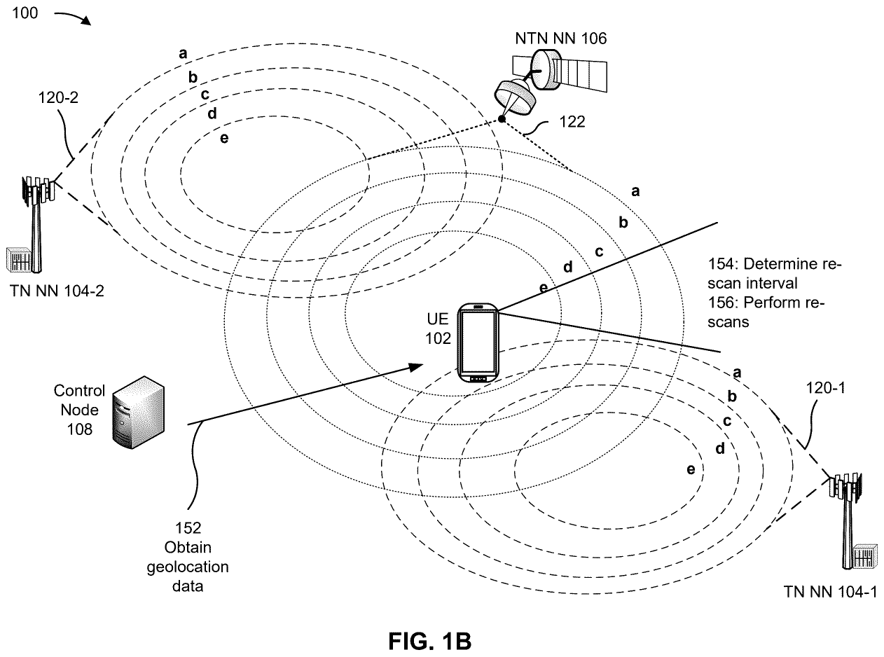

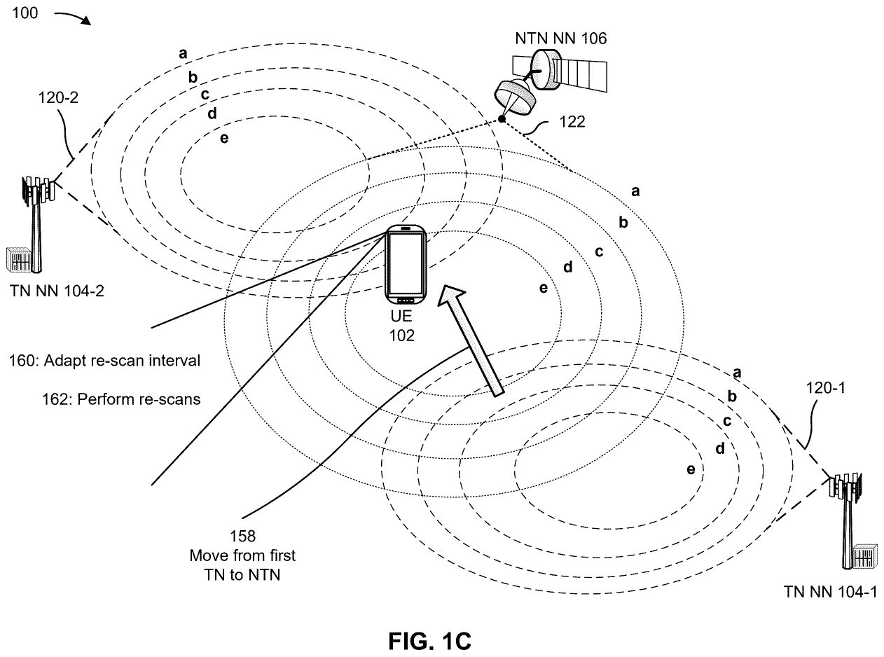

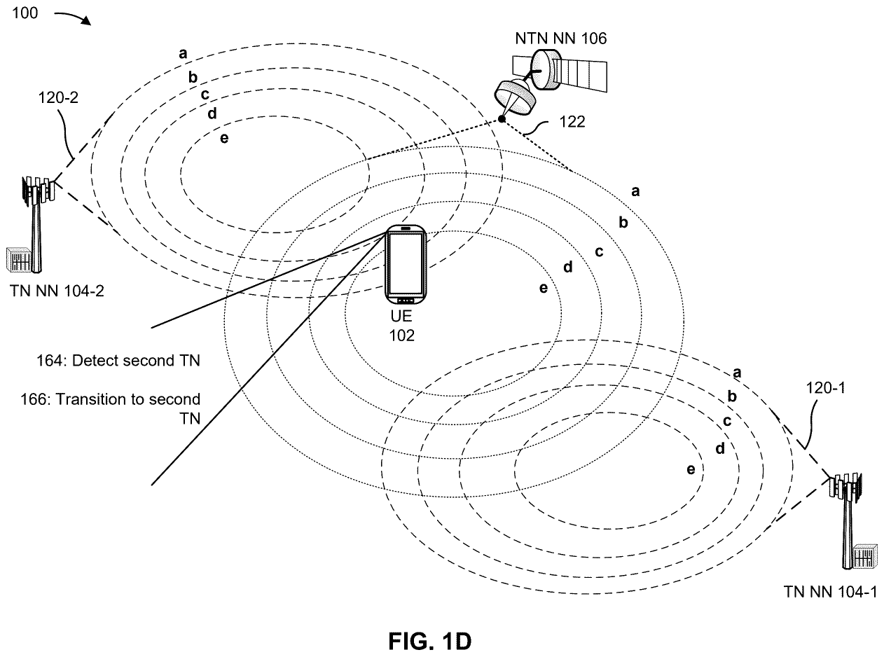

FIGS. 1A-1D are diagrams of an example 100 associated with network selection using geolocation data. As shown in FIGS. 1A-1D, example 100 includes a UE 102, a set of TN network nodes 104 (e.g., a TN network node 104-1 and a TN network node 104-2), and an NTN network node 106. In some implementations, the network nodes 104/106 may be associated with providing a set of networks (e.g., cells). For example, the TN network node 104-1 may provide a first terrestrial network 120-1 and the TN network node 104-2 may provide a second terrestrial network 120-2. In a white space positioned approximately between the first terrestrial network 120-1 and the second terrestrial network 120-2, the NTN network node 106 may provide a non-terrestrial network 122.

As shown by FIG. 1A, and reference number 150, the UE 102 may move from a first terrestrial network 120-1 served by the TN network node 104-1 to a non-terrestrial network 122 served by the NTN network node 106. For example, the UE 102 may initially be connected to the first TN network node 104-1 and, upon moving beyond the coverage area of the first TN network node 104-1, may switch to the NTN NN 106. As illustrated, a network may provide coverage to an area, such that a segment a (e.g., an area outside of an outermost line illustrated for a corresponding network) represents an out-of-coverage area, a segment b represents a cell edge (e.g., an area within the outermost line but outside a next outermost line illustrated for a corresponding network), a segment e represents a cell core (e.g., an area within an innermost line illustrated for a corresponding network), and segments c and d represent areas between the cell edge and the cell core. Although some implementations are described herein in terms of segments associated with distances from a cell center (e.g., from a network node), it is contemplated that the segments may be associated with levels of a network metric. Further it is contemplated that rather than discrete segments, a network may be characterized on another scale, such as a continuous scale. Additionally, although segments a through e are depicted as concentric areas, cell coverage may be associated with irregular patterns, dead zones (e.g., smaller areas with a lack of network coverage within a larger area that otherwise has network coverage), overlapping network coverage, and/or other arrangements.

When the UE 102 moves toward the out-of-coverage area a of the terrestrial network 120-1 and toward the cell core e of the non-terrestrial network 122, the UE 102 may transfer, reselect, and/or handover from the terrestrial network 120-1 to the non-terrestrial network 122 to maintain cell connectivity. Although some implementations are described herein in terms of segments a through e, other network area divisions may be used.

As further shown in FIG. 1B, by reference number 152, the UE 102 may obtain geolocation data. For example, the UE 102 may obtain the geolocation data from the control node 108 (e.g., via a network connection, such as via the NTN network node 106). In this case, the geolocation data may be used to determine whether the UE 102 is in a white space area or in a terrestrial network coverage area. In some implementations, the UE 102 may obtain the geolocation data based on transitioning to the non-terrestrial network 122. For example, the UE 102 may obtain the geolocation data to use for re-scanning to enable a transition back to a terrestrial network, such as the terrestrial network 120-2. Additionally, or alternatively, the UE 102 may obtain the geolocation data when connected to the terrestrial network 120-1, store the geolocation data in a data structure, and recall the geolocation data based on transitioning to the non-terrestrial network 122.

In some implementations, geolocation data acquisition may include the UE 102 obtaining geolocation data from a crowdsourced database. For example, the control node 108 may receive crowdsourced data from many UEs and may provide the crowdsourced data to provide more up-to-date and extensive coverage information, than may be provided with static data, based on the experiences of the many UEs. In some implementations, the geolocation data acquisition may include geolocation data being received from a network management server rather than directly from a control node. Such data may include additional context about network performance and available resources, facilitating decision-making by the UE 102, as described herein.

In some implementations, geolocation data may include tracking area (TA) data. For example, the UE 102 may identify a TA or TA range that is in a core or edge of a terrestrial network 120. When transitioning among networks, the UE 102 may use a last terrestrial TA or TA range for identifying a location and/or a set of terrestrial networks 120 for which to scan. In this case, the UE 102 may preference one or more TAs or TA ranges that are determined to be associated with an edge of an area within a terrestrial network coverage area. Additionally, or alternatively, the UE 102 may use cell identifier (ID) data. For example, the UE 102 may use a cell ID or cell ID range to estimate a geolocation of the UE 102. In some implementations, the UE 102 may receive geo-contour data demarcating a set of white spaces or coverage holes. For example, the UE 102 may receive data identifying a location (e.g., a latitude and longitude) of a known coverage hole location and a radius to the known coverage hole location, from which the UE 102 may estimate a position of the UE 102. In some implementations, the UE 102 may use interpolation to predict a geolocation of the UE 102. In some implementations, the UE 102 may use crowdsourced data identifying locations at which a network to which the UE 102 is connected is available.

In some implementations, the UE 102 may obtain geolocation data using one or more location determination techniques or components, such as using global navigation satellite system (GNSS) positioning (e.g., global positioning system (GPS) positioning), Wi-Fi positioning, or cellular triangulation. The UE 102 may periodically send location data to the control node 108, which aggregates data from multiple UEs to create a geolocation dataset. This aggregated data may then be used to update the UE 102 with the latest geolocation information, ensuring that the UE 102 has accurate and up-to-date location data. In some implementations, the geolocation data may be stored in a local database on the UE 102 for quick access and may be used to determine the proximity to terrestrial network coverage areas.

In some implementations, the UE 102 may use a push or pull application or applet to obtain geolocation data from the control node 108. Additionally, or alternatively, the UE 102 may use a device management service to obtain geolocation data. Additionally, or alternatively, the UE 102 may communicate with one or more other devices to obtain geolocation data (e.g., crowdsourced data).

As further shown in FIG. 1B, and by reference numbers 154 and 156, the UE 102 may determine a re-scan interval for seeking terrestrial network coverage and perform re-scans based on the determined interval. For example, the UE 102 may adjust the re-scan interval based on a current geolocation of the UE 102. Additionally, or alternatively, the UE 102 may adjust the re-scan interval based on a proximity of a current geolocation of the UE 012 to a terrestrial network coverage area, such as a coverage area of the second terrestrial network 120-2. In some implementations, the UE 102 may determine the re-scan interval based on a result of a prior re-scan, such as using a telescoping algorithm. In some implementations, the UE 102 may utilize a telescoping algorithm for re-scan intervals, which increases the time between scans if no terrestrial network is found, thereby conserving battery life.

A telescoping algorithm may use one or more factors, such as a battery conservation factor, a network re-acquisition time factor, or a user activity level factor, among other examples. For example, if the UE 102 detects that the UE 102 is stationary, a telescoping algorithm may generate a value for the re-scan interval that may reduce the scan frequency, whereas if the user is moving toward a known coverage area, it might increase the scan frequency. In other words, the UE 102 may increase an amount of time of the re-scan interval for a next re-scan after each unsuccessful re-scan (e.g., in which a terrestrial network 120 is not detected) to attempt to reduce battery utilization. In contrast, when a terrestrial network 120 is detected but a transition is not successful (e.g., as a result of a signal strength being too low), the UE 102 may decrease the amount of time of the re-scan interval for a next re-scan, to attempt to detect and connect to a terrestrial network 120 more quickly.

In some implementations, the UE 102 may determine the re-scan interval based on whether the UE 102 is in a white space or a coverage hole. “White space” refers to an area that is predicted to be outside a coverage area of a terrestrial network 120. “Coverage hole” refers to an area within the coverage area of a terrestrial network 120 that lacks coverage (e.g., as a result of objects blocking signals, geographic features, or another form of interference). The UE 102 may select a relatively high-frequency re-scan interval when in a coverage hole, as the UE 102 may quickly exit the coverage hole and re-enter coverage of a terrestrial network 120. In contrast, the UE 102 may select a relatively low-frequency re-scan interval when in a white space, as a coverage of a terrestrial network 120 is not predicted to be available.

In some implementations, determining re-scan intervals may include the UE 102 determining the re-scan interval using a machine learning model that predicts network coverage areas based on historical data. For example, the UE 102 may use a machine learning model to analyze past connectivity patterns and environmental factors to estimate a re-scan interval balancing a set of optimization factors, such as a battery life metric, a battery life utilization for re-scan, a performance improvement from switching to a terrestrial network, an overhead associated with re-scan, and/or another factor. Additionally, or alternatively, determining re-scan intervals may include the UE 102 determining the re-scan interval based on a set of configured thresholds. For example, the UE 102 may prioritize energy-efficient re-scanning (e.g., a low re-scan frequency) when the UE 102 has a battery level less than a threshold value. In contrast, when the battery level is greater than a threshold value, the UE 102 may select a higher re-scan frequency.

Additionally, or alternatively, the UE 102 may select a re-scan interval based on a set of network characteristics. For example, when a network congestion level on the non-terrestrial network 122 is high and respective network congestion levels of one or more neighboring terrestrial networks 120 are low, the UE 102 may set a higher re-scan frequency to prioritize transferring away from the congested non-terrestrial network 122.

In some implementations, the UE 102 may determine whether to perform re-scanning based on a transition timer. For example, when the UE 102 transitions between cells (e.g., from terrestrial network 120-1 to non-terrestrial network 122), the UE 102 may set a transition timer for a configured period of time. During the configured period of time when the transition timer has an active status, the UE 102 may suppress performing re-scans (or may use a reduced re-scan interval relative to when the timer is not active). In this case, after the transition timer expires, the UE 102 may resume performing re-scanning. By prohibiting or suspending re-scanning for a configured period of time after a cell change (e.g., using the transition timer), the UE 102 may avoid ping-ponging between cells, when would result in excess utilization of battery resources and network overhead.

As shown in FIG. 1C, and by reference number 158, the UE 102 may move between networks. For example, the UE 102 may move from the first terrestrial network 120-1 toward the non-terrestrial network 122. Additionally, or alternatively, the UE 102 may move from the non-terrestrial network 122 toward the second terrestrial network 120-2. In some implementations, the UE 102 may trigger one or more re-scans during movement. For example, the UE 102 may re-scan for a terrestrial network 120 when connected to a non-terrestrial network 122. As the UE 102 moves, the UE 102 may change one or more parameters. For example, as shown by reference numbers 160 and 162, the UE 102 may adapt the re-scan interval and perform re-scans as the UE 102 moves closer to a terrestrial network coverage area. For example, as the UE 102 moves from segment a to segment c of the second terrestrial network 120-2 (e.g., based on the geolocation data), the UE 102 may dynamically adjust the re-scan interval to become more frequent, to quickly re-acquire terrestrial network coverage (e.g., based on a higher likelihood of successfully re-acquiring terrestrial network coverage closer to a cell core relative to a cell edge). In some implementations, the UE 102 may proactively adapt the re-scan interval based on a predicted future location or a trajectory. For example, the UE 102 may determine that, at a particular time, the UE 102 may be at segment c of the second terrestrial network 120-2, and may proactively adapt the re-scan interval to a re-scan interval configured for UEs within segment c, thereby reducing a delay associated with adapting the re-scan interval.

In some implementations, the UE 102 may adapt the re-scan intervals dynamically based on real-time user activity, such as data usage patterns. For example, if a user is actively using data-intensive applications, the UE 102 may adjust the re-scan intervals to be shortened, to trigger a quicker transfer to the second terrestrial network 120-2 to ensure robust connectivity. In some implementations, the UE 102 may receive periodic updates to re-scan intervals based on network performance metrics sent from the network provider. For example, periodic updates may include adjustments to re-scan intervals or tuning of a re-scan interval determination algorithm to reflect the changing network conditions or performance optimizations.

In some implementations, the UE 102 may use a machine learning algorithm to predict a likelihood of terrestrial network availability based on historical data. For example, the UE 102 may use a neural network trained on past connectivity patterns and environmental factors to estimate a re-scan interval (e.g., an optimal re-scan interval or an optimized re-scan interval given a set of factors). The neural network model may use factors such as time of day, movement speed, battery level, and past signal strength data to dynamically adjust the re-scan frequency.

The UE 102 may log re-scan events. For example, the UE 102 may log re-scan events with a timestamp, geolocation data, or a success or failure of each re-scan. The UE 102 may use the log to refine an accuracy of the geolocation data and to improve the performance of a machine learning model over time. For example, if the UE 102 fails to find a terrestrial network in a particular area, the UE 102 may adjust the machine learning model to generate predictions that reflect a lack of terrestrial network coverage in the particular area, thereby improving future performance

As shown in FIG. 1D, and by reference numbers 164 and 166, the UE 102 may detect the second terrestrial network 120-2 and transition to the second terrestrial network 120-2. For example, based on scanning for a terrestrial network in accordance with a re-scan interval, the UE 102 may detect a signal from the terrestrial network 120-2, and the UE 102 may transition from the non-terrestrial network 122 to the terrestrial network 120-2. In some implementations, the UE 102 may detect terrestrial network nodes 104 in connection with a cell ID or tracking area (TA). For example, the UE 102 may use cell ID or TA data to identify which terrestrial networks 120 are proximate to a geolocation of the UE 102. In some implementations, the UE 102 may verify a signal strength before transitioning to the TN network node 104-2. For example, the UE 102 may evaluate the signal quality to ensure that the signal quality or signal strength exceeds a threshold value associated with obtaining a reliable connection. In this case, by evaluating the signal strength or quality, the UE 102 may reduce a likelihood of ping-ponging between networks.

As indicated above, FIGS. 1A-1D are provided as an example. Other examples may differ from what is described with regard to FIGS. 1A-1D.

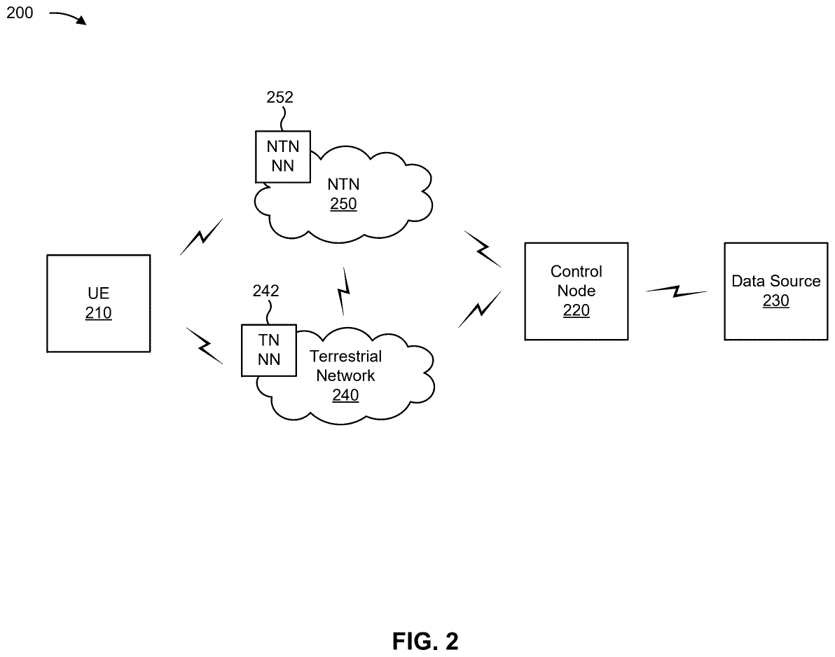

FIG. 2 is a diagram of an example environment 200 in which systems and/or methods described herein may be implemented. As shown in FIG. 2, environment 200 may include a UE 210, a control node 220, a data source 230, a terrestrial network 240, a terrestrial network (TN) network node device 242 (which is depicted as “TN NN 242” and which may be referred to as TN network node 242), a non-terrestrial network 250, a non-terrestrial network (NTN) network node 252 (which is depicted as “NTN NN 252” and which may be referred to as NTN network node 252). In some implementations, one or more other networks may be associated with devices of the environment 200, such as a core network. Devices of environment 200 may interconnect via wired connections, wireless connections, or a combination of wired and wireless connections.

The UE 210 may include one or more devices capable of receiving, generating, storing, processing, and/or providing information associated with communication via a network, as described elsewhere herein. The UE 210 may include a communication device and/or a computing device. For example, the UE 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The control node 220 may include one or more devices capable of receiving, generating, storing, processing, providing, and/or routing information associated with mobility among a terrestrial network 240 and a non-terrestrial network 250, as described elsewhere herein. The control node 220 may include a communication device and/or a computing device. For example, the control node 220 may include a server, such as an application server, a client server, a web server, a database server, a host server, a proxy server, a virtual server (e.g., executing on computing hardware), or a server in a cloud computing system. In some implementations, the control node 220 may include a core network node, such as an access and mobility management function, a session management function, a policy control function, or another type of core network node. In some implementations, the control node 220 may include computing hardware used in a cloud computing environment.

The data source 230 may include one or more devices capable of receiving, generating, storing, processing, and/or providing information associated with geolocation data, as described elsewhere herein. The data source 230 may include a communication device and/or a computing device. For example, the data source 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data source 230 may store geolocation data, as described elsewhere herein.

The terrestrial network 240 may include one or more wireless networks. For example, the terrestrial network 240 may include a cellular network (e.g., a sixth generation (6G) network, a fifth generation (5G) network, a fourth generation (4G) network, a long-term evolution (LTE) network, a third generation (3G) network, a code division multiple access (CDMA) network, etc.), a wireless local access network (WLAN), or another type of network. The terrestrial network 240 enables communication among the devices of environment 200. In some implementations, the terrestrial network 240 may include one or more ground-based stations. For example, the terrestrial network 240 may include a set of TN network nodes 242 that provide ground-based network connectivity to a set of UEs 210.

The non-terrestrial network 250 may include one or more wireless networks. For example, the non-terrestrial network 250 may include a cellular network (e.g., a 6G network, a 5G network, a 4G network, etc.), or another type of network. The non-terrestrial network 250 enables communication among the devices of environment 200. In some implementations, the non-terrestrial network 250 may include one or more non-ground-based stations, such as one or more satellite-based network nodes, one or more UAV-based network nodes, or one or more manned-aerial-vehicle (MAV)-based network nodes. For example, the non-terrestrial network 250 may include a set of NTN network nodes 252 that provide air-based network connectivity or space-based network connectivity to a set of UEs 210.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

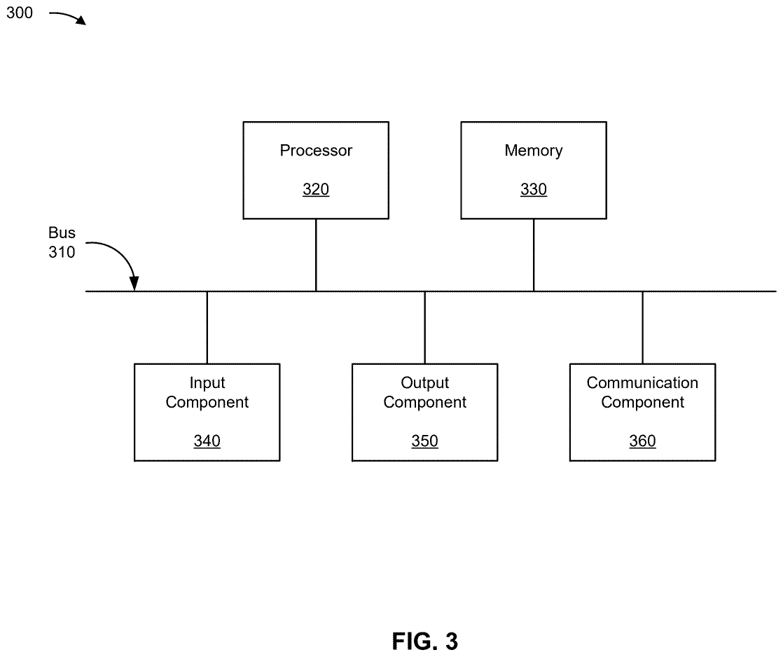

FIG. 3 is a diagram of example components of a device 300 associated with network selection using geolocation data. The device 300 may correspond to the UE 210, the NTN network node 252, the TN network node 242, the control node 220, and/or the data source 230. In some implementations, the UE 210, the NTN network node 252, the TN network node 242, the control node 220, and/or the data source 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

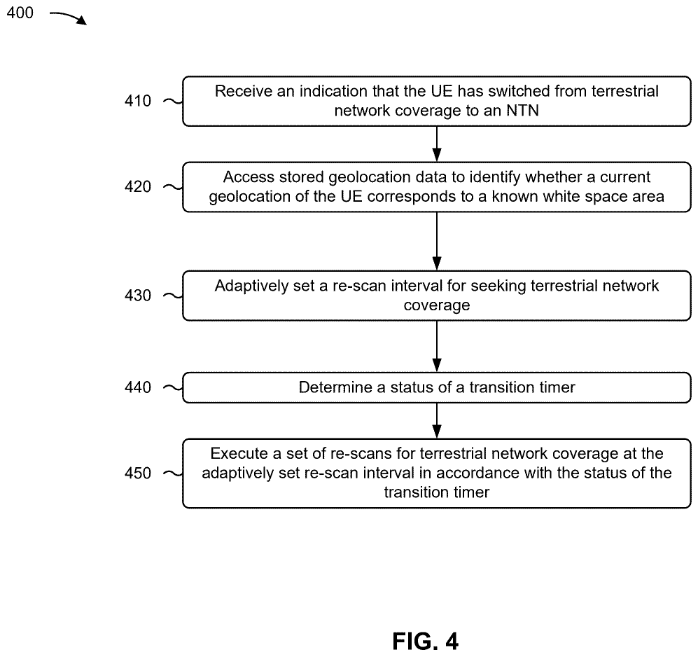

FIG. 4 is a flowchart of an example process 400 associated with network selection using geolocation data. In some implementations, one or more process blocks of FIG. 4 may be performed by a UE (e.g., UE 210). In some implementations, one or more process blocks of FIG. 4 may be performed by another device or a group of devices separate from or including the UE, such as a network node (e.g., the NTN network node 252 or the TN network node 242), a control node (e.g., the control node 220), and/or a data source (e.g., the data source 230). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving an indication that the UE has switched from terrestrial network coverage to an NTN (block 410). For example, the UE may receive an indication that the UE has switched from terrestrial network coverage to an NTN, as described above. In some implementations, the UE may determine that a switch from a terrestrial network to a non-terrestrial network has occurred based on performing a handover or a cell reselection to a network node associated with providing a non-terrestrial network.

As further shown in FIG. 4, process 400 may include accessing stored geolocation data to identify whether a current geolocation of the UE corresponds to a known white space area (block 420). For example, the UE may access stored geolocation data to identify whether a current geolocation of the UE corresponds to a known white space area, as described above. In some implementations, process 400 includes obtaining, from a data structure storing historical geolocation data, data indicating previous instances of NTN use and corresponding locations where terrestrial network coverage occurred previously.

As further shown in FIG. 4, process 400 may include adaptively setting a re-scan interval for seeking terrestrial network coverage (block 430). For example, the UE may adaptively set a re-scan interval for seeking terrestrial network coverage, wherein a value of the re-scan interval is based on whether the current geolocation of the UE corresponds to the known white space area, as described above. In some implementations, process 400 includes adapting a frequency of re-scans based on the UE moving from the current geolocation to a new geolocation, wherein the current geolocation is associated with a first likelihood of terrestrial network coverage and the new geolocation is associated with a second likelihood of terrestrial network coverage.

As further shown in FIG. 4, process 400 may include determining a status of a transition timer (block 440). For example, the UE may determine a status of a transition timer, as described above. The transition timer may include a prohibit timer that is used to block ping-ponging between cells for a period of time after a cell change or network change.

As further shown in FIG. 4, process 400 may include executing a set of re-scans for terrestrial network coverage at the adaptively set re-scan interval in accordance with the status of the transition timer (block 450). For example, the UE may execute a set of re-scans for terrestrial network coverage at the adaptively set re-scan interval in accordance with the status of the transition timer, as described above. In some implementations, process 400 includes initiating the transition timer upon re-acquisition of terrestrial network coverage, to delay subsequent re-scans for a configured period.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a user equipment (UE), geolocation data indicating a current location of the UE;
determining, by the UE, a re-scan interval for re-acquiring a terrestrial network based on the geolocation data, wherein a value for the re-scan interval is based on a proximity to an area within a terrestrial network coverage area; and
performing, by the UE and during connectivity with a non-terrestrial network (NTN), a set of re-scans for the terrestrial network based on the determined re-scan interval.

2. The method of claim 1, further comprising:
adjusting the value of the re-scan interval based on the geolocation data being indicative of the UE being in a core of the area within the terrestrial network coverage area.

3. The method of claim 1, further comprising:
activating a transition timer based on the UE transitioning from the terrestrial network to the NTN; and
suspending re-scans while the transition timer is active.

4. The method of claim 3, further comprising:
resuming re-scans, using the determined re-scan interval, based on an expiration of the transition timer.

5. The method of claim 1, wherein the geolocation data is pushed, from a server, to the UE via an application or applet on the UE.

6. The method of claim 1, wherein the geolocation data is received from crowdsourced locations where other devices have utilized NTNs.

7. The method of claim 1, wherein the re-scan interval is a telescoping algorithm that increases intervals over time, based on a set of factors, wherein the set of factors includes at least one of: a battery conservation factor or a network re-acquisition time factor.

8. The method of claim 1, wherein the geolocation data includes tracking areas (TAs) or TA ranges, and the method further comprises:
identifying one or more TAs or one or more TA ranges that are within a core of the area with terrestrial network coverage; and
preferencing, for the set of re-scans, the one or more TAs or the one or more TA ranges over a TA or TA range that is at an edge of the area with the terrestrial network coverage.

9. The method of claim 1, wherein the geolocation data includes cell identifiers (IDs) or cell ID ranges, and the method further comprising:
identifying one or more cell IDs or one or more cell ID ranges that are within a core of the area with terrestrial network coverage; and
preferencing, for the set of re-scans, the one or more cell IDs or the one or more cell ID ranges over a cell ID or cell ID range that is at an edge of the area with the terrestrial network coverage.

10. The method of claim 1, wherein the geolocation data includes geo-contours demarcating a set of white spaces within the area with terrestrial network coverage, and the method further comprising:
determining the re-scan interval based on the geo-contours.

11. The method of claim 1, further comprising:
modifying the re-scan interval based on a set of battery life metrics of the UE, based on at least one battery life metric having a value that falls below a configured threshold.

12. The method of claim 1, further comprising:
logging re-scan events associated with the set of re-scans; and
adjusting the geolocation data based on a success or failure of the re-scan events to refine an accuracy of data identifying the area with terrestrial network coverage.

13. A user equipment (UE) comprising:
one or more processors configured to:
receive an indication that the UE has switched from terrestrial network coverage to a non-terrestrial network (NTN);
access stored geolocation data to identify whether a current geolocation of the UE corresponds to a known white space area;
adaptively set a re-scan interval for seeking terrestrial network coverage, wherein a value of the re-scan interval is based on whether the current geolocation of the UE corresponds to the known white space area;
determine a status of a transition timer; and
execute a set of re-scans for terrestrial network coverage at the adaptively set re-scan interval in accordance with the status of the transition timer.

14. The UE of claim 13, wherein the one or more processors, to access the stored geolocation data, are further configured to:
obtain, from a data structure storing historical geolocation data, data indicating previous instances of NTN use and corresponding locations where terrestrial network coverage occurred previously.

15. The UE of claim 13, wherein the one or more processors, to adaptively set the re-scan interval, are further configured to:
adapt a frequency of re-scans based on the UE moving from the current geolocation to a new geolocation, wherein the current geolocation is associated with a first likelihood of terrestrial network coverage and the new geolocation is associated with a second likelihood of terrestrial network coverage.

16. The UE of claim 13, wherein the one or more processors are further configured to:
initiate the transition timer upon re-acquisition of terrestrial network coverage, to delay subsequent re-scans for a configured period.

17. A non-transitory computer-readable medium storing a set of instructions, the set of instructions comprising:
one or more instructions that, when executed by one or more processors of a user equipment (UE), cause the UE to:
determine that the UE has transitioned from a terrestrial network to a non-terrestrial network (NTN);
obtain geolocation data associated with a current location of the UE;
identify, based on the geolocation data, a proximity of a current location to an area with expected terrestrial network coverage;
set a re-scan interval for scanning for the terrestrial network based on the current location and the proximity of the current location to the area with expected terrestrial network coverage, wherein the re-scan interval is set to a relatively lower frequency based on the current location being within a known white space and to a relatively higher frequency based on the current location being within a threshold proximity of the area with expected terrestrial network coverage;
initiate a set of re-scans for the terrestrial network based on the re-scan interval; and
establish a connection with the terrestrial network based on the terrestrial network being detected in connection with the set of re-scans.

18. The non-transitory computer-readable medium of claim 17, wherein the one or more instructions, when executed by the one or more processors of the UE, further cause the UE to:
receive updates to the geolocation data indicating new white space areas or changes to areas with expected terrestrial network coverage.

19. The non-transitory computer-readable medium of claim 17, wherein the one or more instructions, when executed by the one or more processors of the UE, further cause the UE to:
generate a report indicating instances of network switching between the NTN and terrestrial networks, the report including timestamps and geolocation data for each instance.

20. The non-transitory computer-readable medium of claim 17, wherein the one or more instructions, when executed by the one or more processors of the UE, further cause the UE to:
receive configuration updates for an adaptive re-scan interval algorithm via a network management service, wherein the configuration updates identify a refinement to the adaptive re-scan interval algorithm based on at least one of: network performance data or battery life metrics.
